(19) United States
(12) Patent Application Publication
(10) Pub. No.: US 2013/0223908 A1
(43) Pub. Date: Aug. 29, 2013

(54) PAPER FEED APPARATUS, IMAGE FORMING APPARATUS, AND PAPER FEED METHOD

(71) Applicant: Kyocera Document Solutions Inc., (US)

(72) Inventor: Kiyotaka YAMAGUCHI, Osaka (JP)

(73) Assignee: KYOCERA DOCUMENT SOLUTIONS INC., Osaka (JP)

(21) Appl. No.: 13/776,916

(22) Filed: Feb. 26, 2013

(30) Foreign Application Priority Data
Feb. 29, 2012 (JP) 2012-044102

(51) Int. Cl. G03G 15/00

(52) U.S. Cl. CPC G03G 15/6529
USPC 399/400; 271/126

(57) ABSTRACT

A paper feed apparatus includes a paper housing unit configured to house paper at a first position, a bottom plate provided in the paper housing unit and configured to retain the paper, a moving unit configured to move the bottom plate between the first position and a second position, a paper feed roller configured to feed the paper retained by the bottom plate at the second position, and a paper feed control unit configured to cause the moving unit to move the bottom plate to the second position when a paper feed preparation request for requesting paper feed preparation has been input.

### BACKGROUND OF THE DISCLOSURE

This application is based upon and claims the benefit of priority from prior Japanese Patent Application No. 2012-044102, filed Feb. 29, 2012, the entire contents of which are incorporated herein.

### FIELD OF THE DISCLOSURE

The present disclosure relates to a paper feed apparatus, an image forming apparatus, and a paper feed method.

### DESCRIPTION OF RELATED ART

Image forming apparatuses such as a printer, a copier, and a composite device form an image on paper by carrying a toner image of an image to be formed on an image carrier such as a photoconductive drum and transferring the toner image to the paper (print paper) to fix the transferred image thereon. Thus, the image forming apparatus includes a paper feed apparatus, which feeds paper housed in a paper housing unit sheet by sheet every time the tonner image is carried by the image carrier.

The paper feed apparatus lifts a bottom plate (a plate that retains a paper stack housed in the paper housing unit) provided at the bottom of the paper housing unit, and arranges the paper stack at a paper feed-enabled position (a position at which paper can be fed from the paper feed apparatus). At the paper feed-enabled position, paper arranged at the top of the paper stack is fed by causing the paper stack to be in pressure contact with a paper feed roller (pickup roller) that rotates in a paper feed direction.

Here, if the paper stack remains in a state of pressure contact with the pickup roller when the paper is fed from the paper feed apparatus, a phenomenon (multi-feeding) in which a plurality of sheets of paper are simultaneously fed may occur.

As a solution for solving the multi-feeding, there is technology for feeding paper using the pickup roller by lifting the bottom plate provided on the paper housing unit when a paper feed request (paper feed start signal) has been received and arranging the paper stack at the paper feed-enabled position. In this technology, the multi-feeding of paper is prevented by lowering the bottom plate to an intermediate position a given time after the paper has been fed and causing the bottom plate to be on standby at the intermediate position.

In the above-described technology, the paper is fed by lifting the bottom plate after the paper feed request has been received and arranging the paper stack at the paper feed-enabled position. In addition, when no paper feed request has been received, the bottom plate is lowered and caused to be on standby at the intermediate position. Thus, in the paper feed apparatus according to the above-described technology, it is necessary to postpone the lift of the bottom plate until the paper stack is arranged at the paper feed-enabled position after the paper feed request is received. Consequently, there is a problem in that a time taken to form (print) an image is lengthened by a waiting time and hence productivity is degraded. In particular, when paper is fed while switching between a plurality of paper housing units (paper feed stages) is performed, there is a problem in that productivity is significantly degraded because the above-described waiting time occurs every time the paper feed stage is switched.

On the other hand, when the bottom plate remains lifted, a state in which the paper stack is in pressure contact with the pickup roller is maintained. Thus, when the paper housing unit has been pulled out for paper supply or the like, the loss of paper in pressure contact with the pickup roller, the deformation of the pickup roller, or the like is likely to occur.

### SUMMARY

An object of the present disclosure is to provide a paper feed apparatus, an image forming apparatus, and a paper feed method capable of improving productivity by shortening a waiting time for paper feeding according to a lift of a bottom plate.

A first aspect of the present disclosure is a paper feed apparatus including a paper housing unit configured to house paper at a first position, a bottom plate provided in the paper housing unit and configured to retain the paper, a moving unit configured to move the bottom plate between the first position and a second position, a paper feed roller configured to feed the paper retained by the bottom plate at the second position, and a paper feed control unit configured to cause the moving unit to move the bottom plate to the second position when a paper feed preparation request for requesting paper feed preparation has been input.

A second aspect of the present disclosure is an image forming apparatus including a paper housing unit configured to house paper at a first position, a bottom plate provided in the paper housing unit and configured to retain the paper, a moving unit configured to move the bottom plate between the first position and a second position, a paper feed roller configured to feed the paper retained by the bottom plate at the second position, a paper feed preparation request output unit configured to output a paper feed preparation request for requesting paper feed preparation, a paper feed control unit configured to cause the moving unit to move the bottom plate to the second position when the paper feed preparation request has been output, a transfer unit configured to transfer a toner image of an image to be formed to the paper fed by the paper feed roller, and a fixing unit configured to fix the toner image transferred by the transfer unit on the paper.

A third aspect of the present disclosure is a paper feed method including housing paper at a first position of a paper housing unit, moving a bottom plate, which is provided in the paper housing unit and retains the paper, to a second position when a paper feed preparation request for requesting paper feed preparation has been input, and feeding, by a paper feed roller, the paper retained by the bottom plate at the second position.

According to the present disclosure, when a paper feed preparation request for requesting paper feed preparation has been input, a bottom plate is lifted until a paper stack is arranged at a paper feed-enabled position by controlling a lifting/lowering apparatus. Thus, when a paper feed request has been input, paper can be immediately fed without waiting for the completion of the lift of the bottom plate and a waiting time for paper feeding according to the lift of the bottom plate can be shortened. Thereby, according to the present disclosure, there is an effect of improving productivity.

### BRIEF DESCRIPTION OF THE DRAWINGS

FIG. 1 is a front perspective view illustrating a configuration of main parts of a composite device as an image forming apparatus in accordance with an embodiment of the present disclosure.

FIG. 2 is a block diagram illustrating an electrical configuration of the composite device as the image formatting apparatus in accordance with the embodiment of the present disclosure.

FIG. 3A is a first diagram illustrating position control to be performed by an optional paper feed unit in the embodiment of the present disclosure.

FIG. 3B is a second diagram illustrating the position control to be performed by the optional paper feed unit in the embodiment of the present disclosure.

FIG. 3C is a third diagram illustrating the position control to be performed by the optional paper feed unit in the embodiment of the present disclosure.

FIG. 4 is a first flowchart illustrating a process to be performed by a control unit in the embodiment of the present disclosure.

FIG. 5 is a second flowchart illustrating a process to be performed by the control unit in the embodiment of the present disclosure.

FIG. 6 is a flowchart illustrating a process to be performed by the optional paper feed unit in the embodiment of the present disclosure.

FIG. 7 is a front view illustrating modified examples of a paper feed apparatus and an image forming apparatus in accordance with the embodiment of the present disclosure.

### DETAILED DESCRIPTION OF THE PREFERRED EMBODIMENTS

Hereinafter, details of a paper feed apparatus and an image forming apparatus in accordance with an embodiment of the present disclosure will be described with reference to the drawings. Hereinafter, an example in which the image forming apparatus is a composite device will be described.

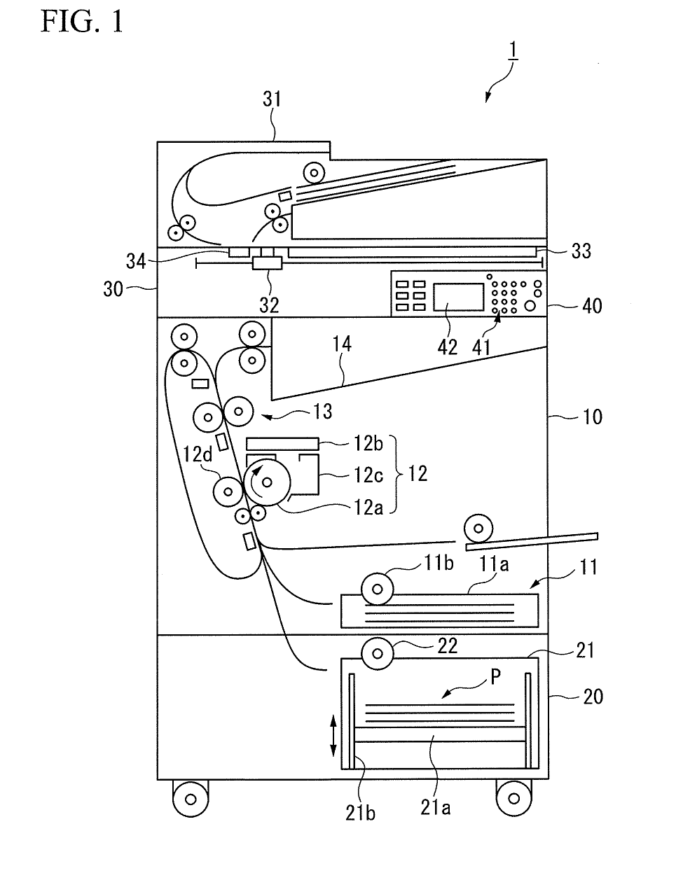

FIG. 1 is a front perspective view illustrating a configuration of main parts of the composite device as the image forming apparatus in accordance with the embodiment of the present disclosure. As illustrated in FIG. 1, the composite device 1 includes a main body unit 10, an optional paper feed unit 20 (a paper feed apparatus), an original document reading unit 30, an operation display unit 40, and the like. The composite device 1 has a copy function, a print function, a facsimile transmission/reception function, and the like.

The main body unit 10 includes a paper feed unit 11, an image form unit 12, a fixing unit 13, a paper discharge tray 14, and the like. The main body unit 10 prints an image corresponding to image data on predetermined paper (print paper). The above-described image data, for example, is original document data of an original document read by the original document reading unit 30, print data transmitted from an external terminal apparatus (not illustrated), received facsimile data, or the like.

The paper feed unit 11 includes a paper feed cassette 11a capable of housing a plurality of sheets (for example, about several tens of sheets) of standard paper. The paper feed cassette 11a is arranged at the bottom of the main body unit 10 in which the paper feed cassette 11a can be pulled out from the front of the main body unit 10. Paper at the top among paper housed in the paper feed cassette 11a is drawn out by driving of a pickup roller 11b and transported to the image form unit 12. Although only one paper feed unit 11 (the paper feed cassette 11a and the pickup roller 11b) is illustrated to simplify the illustration in FIG. 1, a plurality of paper feed units 11 may be provided.

The image form unit 12 includes a photoconductive drum 12a (an image carrier), an exposure unit 12b, a developing unit 12c, a transfer unit 12d, and the like. The image form unit 12 forms a toner image corresponding to an image to be printed and transfers the formed toner image to transported paper. The photoconductive drum 12a is a cylindrical photoconductive body that carries a developed toner image with the formation of an electrostatic latent image corresponding to the image to be printed. The exposure unit 12b radiates laser light for forming the electrostatic latent image corresponding to image data to the photoconductive drum 12a.

The developing unit 12c supplies toner to the photoconductive drum 12a on which the electrostatic latent image is formed and hence develops the electrostatic latent image to generate the toner image. The transfer unit 12d transfers the toner image carried on the photoconductive drum 12a to the paper transported from the paper feed unit 11, the optional paper feed unit 20, or the like.

The fixing unit 13 heats and presses the toner image transferred to the paper to fix the heated and pressed toner image on the paper. Thereby, an image corresponding to image data is printed on the paper. The paper discharge tray 14 is a portion on which the paper on which the image has been printed by the fixing unit 13 is placed. The paper discharge tray 14 is provided on the upper portion of the main body unit 10.

The optional paper feed unit 20 is attached to a lower part (bottom) of the main body unit 10. The optional paper feed unit 20 feeds paper to which the toner image is transferred to the main body unit 10 sheet by sheet. The optional paper feed unit 20 includes an optional paper feed cassette 21 (a paper housing unit). The optional paper feed cassette 21 houses a larger number of sheets of paper (for example, about several hundreds to several thousands of sheets) than the paper feed cassette 11a provided in the paper feed unit 11 at a first position. Like the paper feed cassette 11a, the optional paper feed cassette 21 can be pulled out from the front of the main body unit 10.

Specifically, the optional paper feed cassette 21 includes a bottom plate 21a and a lifting/lowering apparatus 21b (a moving unit). The bottom plate 21a retains a paper stack P including a plurality of sheets of paper. The lifting/lowering apparatus 21b lifts/lowers the bottom plate 21a in a vertical direction. Here, although the case in which the lifting/lowering apparatus 21b lifts/lowers the bottom plate 21a in the vertical direction has been described, the lifting/lowering apparatus 21b may move the bottom plate 21a in a horizontal direction according to a structure of a composite device. Although the illustration is simplified in FIG. 1, the lifting/lowering apparatus 21b includes a guide (not illustrated), a motor (not illustrated), and the like. The guide guides the bottom plate 21a in a lifting/lowering direction by supporting the bottom plate 21a without a tilt. The motor generates a driving force to lift/lower the bottom plate 21a.

If the bottom plate 21a is lifted until the top of the paper stack P is in pressure contact with the pickup roller 22 (the paper feed roller) (until the paper stack to be fed is arranged at the paper feed-enabled position), paper at the top of the paper stack P housed in the paper feed cassette 21 is drawn out by driving of the pickup roller 22 and transported to the image form unit 12 of the main body unit 10. Although only one optional paper feed unit 20 is illustrated to simplify the illustration in FIG. 1, optional paper feed units 20 of a plurality of stages may be provided.

The original document reading unit 30 includes an automatic document feeder (ADF) (automatic original document feed apparatus) 31, a carriage 32, an original document platen 33, and an original document reading slit 34, and the like. The original document reading unit 30 outputs original document data by reading an original document of which paper is sequentially fed by the ADF 31 or the original document placed on the original document platen 33. The ADF 31 is an apparatus for sequentially feeding paper of the original document to be read. The carriage 32 is equipped with an exposure lamp, a charge coupled device (CCD) sensor, and the like. The carriage 32 reads the original document of which paper is sequentially fed by the ADF 31 or the original document placed on the original document platen 33.

Specifically, when the original document placed on the original document platen 33 is read, the carriage 32 reads the original document using the CCD sensor while moving in a longitudinal direction of the original document platen 33. On the other hand, when the original document of which the paper is fed from the ADF 31 is read, the carriage 32 reads the original document of which the paper is sequentially fed from the ADF 31 at a position opposite the original document reading slit 34 (a position of a lower part of the original document reading slit 34) using the CCD sensor via the original document reading slit 34.

The operation display unit 40 includes an operation key unit 41 and a display unit 42. The operation display unit 40 inputs an instruction corresponding to an operation of a user. In addition, the operation display unit 40 displays various information such as information indicating a state of the composite device 1. The operation key unit 41 includes hard keys such as a start key, a stop/clear key, a power key, ten keys (numerical value input keys), a function switching key, and the like. The function switching key is a key for switching the composite device 1 to an operating mode of each function when the user uses each of a copy function, a print function, a scanner function, and a facsimile function. The display unit 42 has a touch panel function. A screen including soft keys is displayed on the display unit 42.

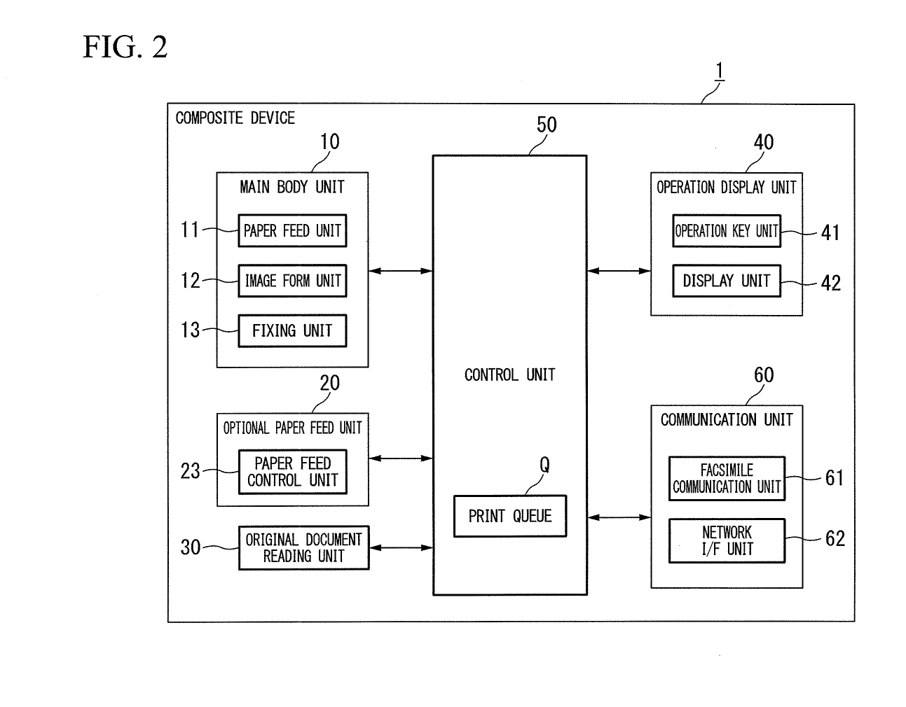

FIG. 2 is a block diagram illustrating an electrical configuration of the composite device as the image formatting apparatus in accordance with the embodiment of the present disclosure. As illustrated in FIG. 2, the main body unit 10, the optional paper feed unit 20, the original document reading unit 30, the operation display unit 40, the control unit 50, and the communication unit 60 are connected to each other using a bus in the composite device 1. Because the main body unit 10, the original document reading unit 30, and the operation display unit 40 among the main body unit 10, the optional paper feed unit 20, the original document reading unit 30, the operation display unit 40, the control unit 50, and the communication unit 60 have been described above, the optional paper feed unit 20, the control unit 50, and the communication unit 60 will be described hereinafter.

The optional paper feed unit 20 includes a paper feed control unit 23. The paper feed control unit 23 performs control for feeding paper to the main body unit 10 based on control of the control unit 50. Specifically, the paper feed control unit 23 controls a position of the bottom plate 21a (the paper stack P retained on the bottom plate 21a) by controlling the lifting/lowering apparatus 21b provided on the optional paper feed cassette 21. In addition, the paper feed control unit 23 performs paper feed control for the main body unit 10 by controlling the pickup roller 22.

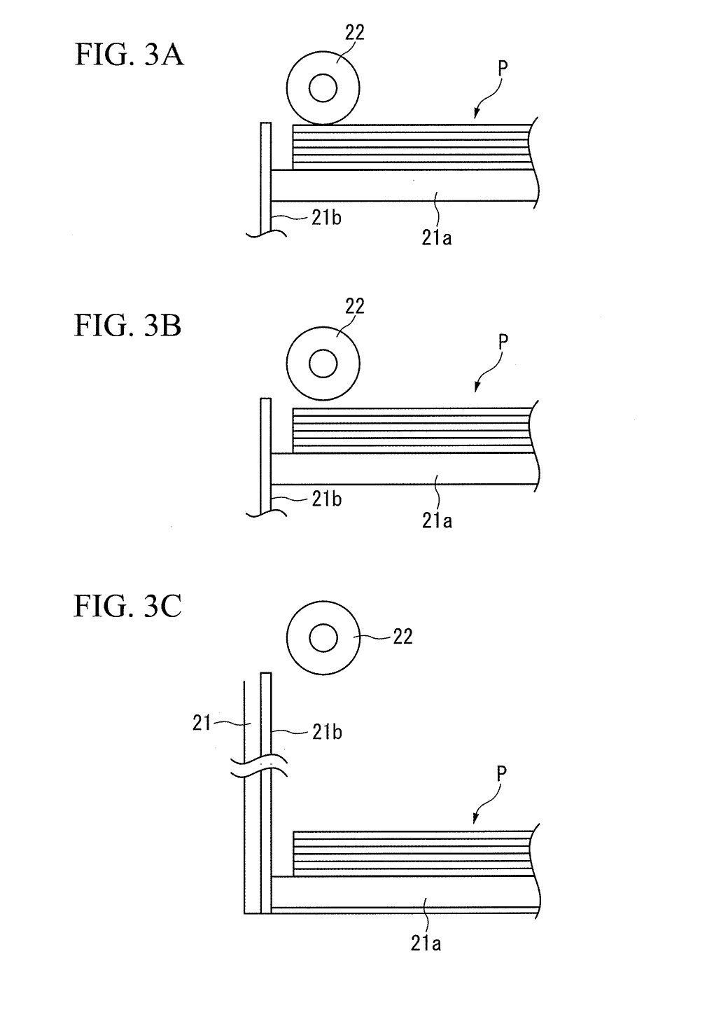

Here, the paper feed control unit 23 arranges the paper stack P (the bottom plate 21a) at a paper feed-enabled position (a second position), a standby position (a third position), or an evacuation position (the first position) according to the above-described position control. FIGS. 3A to 3C are diagrams illustrating position control to be performed by the optional paper feed unit in the embodiment of the present disclosure. FIG. 3A is a diagram illustrating a state in which the paper stack P is arranged at the paper feed-enabled position (second position). FIG. 3B is a diagram illustrating a state in which the bottom plate 21a is arranged at the standby position (third position). FIG. 3C is a diagram illustrating a state in which the bottom plate 21a is arranged at the evacuation position.

As illustrated in FIG. 3A, the above-described paper feed-enabled position is a position at which paper at the top of the paper stack P is drawn out if the top of the paper stack P is in pressure contact with the pickup roller 22 and the pickup roller 22 is driven. As illustrated in FIG. 3B, the above-described standby position is a position set to be slightly below the paper feed-enabled position so that the top of the paper stack P is not in pressure contact with the pickup roller 22. This standby position is set so that a necessary time until the paper stack P is arranged at the paper feed-enabled position is short when the bottom plate 21a is lifted.

In addition, as illustrated in FIG. 3C, the above-described evacuation position is a position at which the bottom plate 21a is not lifted by the lifting/lowering apparatus 21b and the bottom plate 21a is arranged at the very bottom of the optional paper feed cassette 21. The paper stack P (the bottom plate 21a) is arranged at the evacuation position, for example, when power of the composite device 1 is interrupted or when the operating mode of the composite device 1 is set to a power saving mode. In addition, a sensor (not illustrated) detects whether the paper stack P is arranged at the above-described paper feed-enabled position or standby position.

If the paper stack P (the bottom plate 21a) is not arranged at the paper feed-enabled position when a paper feed preparation request has been input from the control unit 50, the paper feed control unit 23 controls the lifting/lowering apparatus 21b to lift the bottom plate 21a until the paper stack P (the bottom plate 21a) is arranged at the paper feed-enabled position (paper feed preparation control). Here, the above-described paper feed preparation request is a request generated by the control unit 50 for causing the optional paper feed unit 20 to prepare paper feeding. The above-described paper feed preparation control is performed to improve productivity by shortening a waiting time for paper feeding (a waiting time until the paper stack P is arranged at the paper feed-enabled position).

In addition, when a paper feed request has been input from the control unit 50 after the paper feed preparation control has been performed, the paper feed control unit 23 performs paper feed control for the main body unit 10 by controlling the pickup roller 22. Here, the above-described paper feed request is a request generated by the control unit 50 for causing the optional paper feed unit 20 to start paper feeding. If the paper feed request has been input from the control unit 50 when the paper stack P (the bottom plate 21a) is not arranged at the paper feed-enabled position, paper feed control for the main body unit 10 is performed by controlling the pickup roller 22 after the paper stack P (the bottom plate 21a) is arranged at the paper feed-enabled position by lifting the bottom plate 21a as in the related art.

Further, after the paper feeding is completed based on the paper feed request from the control unit 50, the paper feed control unit 23 continuously retains the paper stack (the bottom plate 21a) during a predefined retention period. This, for example, is because the productivity is improved by shortening the waiting time for the paper feeding even when the paper feeding from the paper feed unit 11 provided in the main body unit 10 and the paper feeding from the optional paper feed unit 20 are alternately performed. Here, the above-described retention period is set in consideration of a time necessary to lift the bottom plate 21a from the standby position to the paper feed-enabled position, processing capability (the number of print sheets per unit time) of the composite device 1, and the like. For example, the retention period is preferably one minute to five minutes, and further preferably two minutes to four minutes.

When no paper feed preparation request has been input from the control unit 50 by the time the above-described retention period has elapsed, the paper feed control unit 23 controls the bottom plate 21a to be arranged at the standby position by controlling the lifting/lowering apparatus 21b to lower the bottom plate 21a from the paper feed-enabled position illustrated in FIG. 3A to the standby position illustrated in FIG. 3B. This control is performed because the following problem occurs if the paper stack P (the bottom plate 21a) remains arranged at the paper feed-enabled position. That is, when the paper housing unit has been pulled out to supply paper, there is a problem such as the loss of paper (loss of paper pressed on the pickup roller 22), the deformation of the pickup roller 22, or the like.

The control unit 50 includes a central processing unit (CPU), a read only memory (ROM), a random access memory (RAM), an image memory, and the like. The control unit 50 generally controls the operation of the composite device 1. The CPU controls each block illustrated in FIG. 2 based on a control program stored in the ROM. The RAM is used to temporarily store data or the like necessary to execute the control program. The image memory temporarily stores image data (original document data of an original document read by the original document reading unit 30, print data transmitted from an external terminal apparatus (not illustrated), received facsimile data, or the like).

Here, a print queue Q (storage unit), which is an area storing a job (image formation instruction), which is a print instruction for paper, is provided in the RAM provided in the control unit 50. Every time the operation key unit 41 provided in the operation display unit 40 of the composite device 1 is operated and the print instruction is input or every time the print instruction is transmitted from an external terminal apparatus (not illustrated), a new job is sequentially stored in the print queue Q. In addition, a job in which print has been completed is sequentially deleted from the print queue Q.

The control unit 50 refers to the print queue Q every time a new job is stored in the print queue Q, and determines whether to output the paper feed preparation request to the optional paper feed unit 20. When determining to output the paper feed preparation request to the optional paper feed unit 20, the control unit 50 immediately outputs the paper feed preparation request to the optional paper feed unit 20.

Specifically, the control unit 50 determines whether to output the paper feed preparation request to the optional paper feed unit 20 based on whether a job, which requires paper feeding from the optional paper feed unit 20, is stored in the print queue Q.

In addition, the control unit 50, for example, refers to the print queue Q in a given cycle, and outputs a paper feed request to the paper feed control unit 23 when a job in which print is not completed is stored in the print queue Q. Specifically, when the oldest job in which the print is not completed among jobs stored in the print queues Q is a job to print on paper stored in the paper feed unit 11 of the main body unit 10, the control unit 50 outputs the paper feed request to the paper feed unit 11 when the paper feeding from the paper feed unit 11 is possible. In addition, if paper feeding from the optional paper feed unit 20 is possible when the oldest job in which the print is not completed is a job to print on paper stored in the optional paper feed unit 20, the paper feed request is output to the optional paper feed unit 20.

The communication unit 60 includes a facsimile communication unit 61 and a network interface (I/F) unit 62. The facsimile communication unit 61 communicates with a communication partner facsimile connected to a public telephone line. The network I/F unit 62, for example, is connected to a local area network (LAN), and communicates with a terminal apparatus such as a personal computer connected to the same LAN.

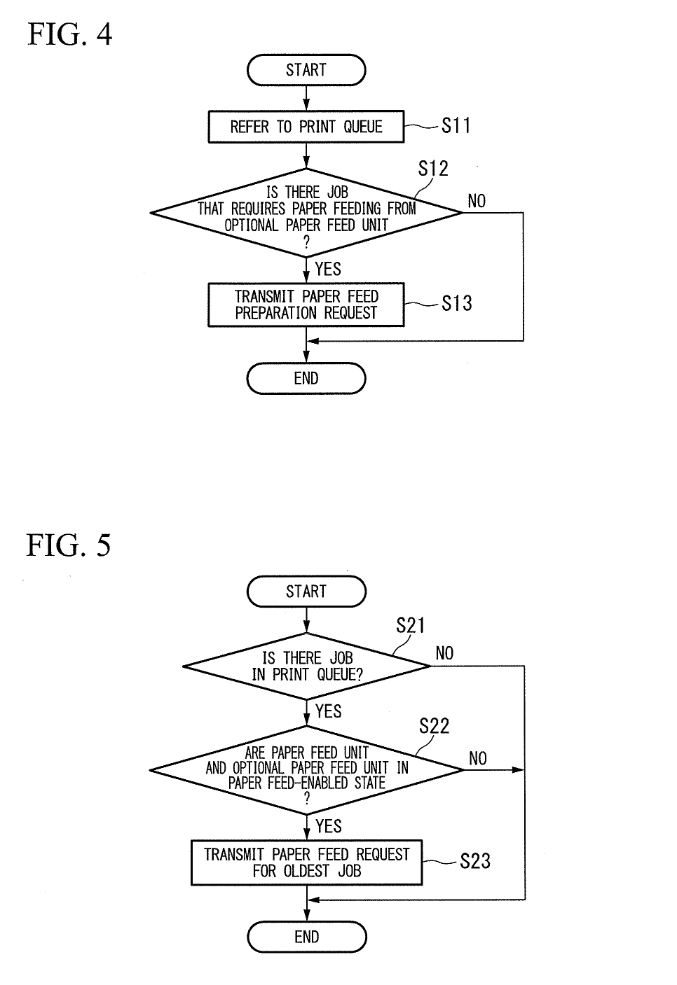

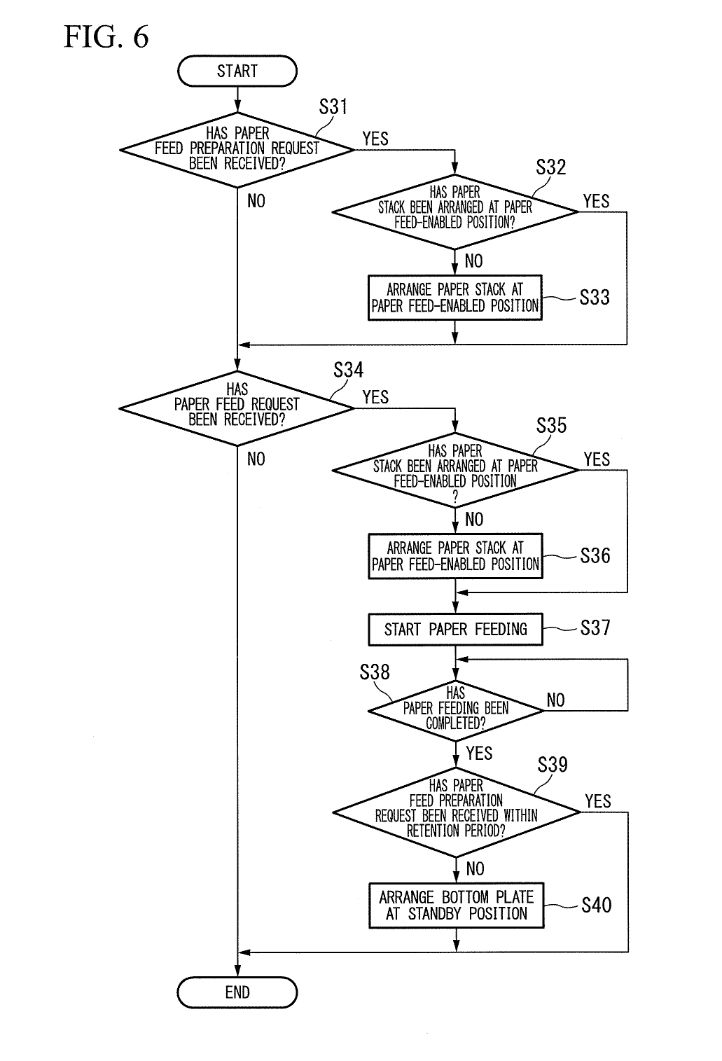

Next, the operation of the composite device 1 in the above-described configuration will be described. FIGS. 4 and 5 are flowcharts illustrating a process to be performed by the control unit 50 in the embodiment of the present disclosure. FIG. 6 is a flowchart illustrating a process to be performed by the optional paper feed unit 20 in the embodiment of the present disclosure. The flowchart illustrated in FIG. 4 is executed every time a new job is stored in the print queue Q. The flowchart illustrated in FIG. 5, for example, is executed in a given cycle. The flowchart illustrated in FIG. 6, for example, is executed in a given cycle after the composite device 1 is powered on and the initialization of the optional paper feed unit 20 ends.

In order to facilitate understanding hereinafter, the case in which paper of an “A4” size is housed in the paper feed unit 11 provided in the main body unit 10 of the composite device 1 will be described. In addition, the case in which paper of a size (for example, paper of a “B5” size) different from that of paper housed in the paper feed unit 11 is housed in the optional paper feed unit 20 will be described. In addition, an operation when a predetermined job has been transmitted from the terminal apparatus connected to the LAN to the composite device 1 in the case in which no job is stored in the print queue Q of the control unit 50 will be described. Here, the predetermined job is a job indicating a print instruction for printing materials in which paper of the “A4” size and paper of the “B5” size are mixed.

The job transmitted from the terminal apparatus to the composite device 1 via the LAN is received by the network I/F unit 62 of the composite device 1, and stored in the print queue Q of the control unit 50. If the job from the terminal apparatus is stored in the print queue Q, the control unit 50 refers to the print queue Q (step S11 in FIG. 4). Then, the control unit 50 determines whether a job, which requires paper feeding from the optional paper feed cassette, is stored in the print queue Q (step S12).

Here, a job indicating a print instruction for printing materials in which paper of the “A4” size housed in the paper feed unit 11 and paper of the “B5” size housed in the optional paper feed unit 20 are mixed is stored in the print queue Q. Thus, the determination result of step S12 indicates “YES,” and the control unit 50 transmits a paper feed preparation request to the optional paper feed unit 20 (step S13).

When the control unit 50 determines that the job, which requires the paper feeding from the optional paper feed unit 20, is not stored in the print queue Q (for example, when only a job indicating a print instruction for paper of the “A4” size housed in the paper feed unit 11 is stored in the print queue Q), the process of step S13 is not performed (the paper feed preparation request is not transmitted), and a series of processes illustrated in FIG. 4 ends. Here, the flowchart illustrated in FIG. 4 is iterated every time a new job is stored in the print queue Q.

In addition, in the control unit 50, the flowchart illustrated in FIG. 5, for example, is executed in a given cycle separately from the flowchart illustrated in FIG. 4. First, the control unit 50 determines whether there is a job in the print queue Q (step S21 in FIG. 5). Here, because a job indicating a print instruction for printing materials in which paper of different sizes is mixed is stored in the print queue Q, the determination result of step S21 is “YES.” When no job is stored in the print queue Q, the determination result of step S21 is “NO” and a series of processes illustrated in FIG. 5 ends.

When it is determined that there is a job in the print queue Q (when the determination result of step S21 is “YES”), the control unit 50 determines whether the paper feed unit 11 and the optional paper feed unit 20 are in the paper feed-enabled state (step S22). Here, the case in which the above-described job (a job indicating a print instruction for printing materials in which paper of different sizes is mixed) is newly stored when no job is stored in the print queue Q of the control unit 50 and paper feeding from the paper feed unit 11 and the optional paper feed unit 20 is not performed will be described. Thus, the determination result of step S22 is “YES.”

When a previous job is stored in the print queue Q and paper feeding from any one of the paper feed unit 11 and the optional paper feed unit 20 is actually performed, the determination result of step S22 is “NO” and the series of processes illustrated in FIG. 5 ends. However, even when a previous job is stored in the print queue Q, the determination result of step S22 is “YES” if the print of the last page in the job ends and the paper feed unit 11 and the optional paper feed unit 20 are in the paper feed-enabled state.

When it is determined that the paper feed unit 11 and the optional paper feed unit 20 are in the paper feed-enabled state (when the determination result of step S22 is “YES”), a paper feed request for the oldest job among jobs stored in the print queue Q is transmitted from the control unit 50 to the paper feed unit 11 or the optional paper feed unit 20 (step S23). Here, the oldest job stored in the print queue Q is a job indicating a print instruction for printing materials in which paper of the “A4” size housed in the paper feed unit 11 and paper of the “B5” size housed in the optional paper feed unit 20 are mixed. Thus, first, the paper feed request is transmitted from the control unit 50 to the paper feed unit 11, and then the paper feed request is transmitted from the control unit 50 to the optional paper feed unit 20.

In parallel with the operation of the control unit 50 described above, in the optional paper feed unit 20, the flowchart illustrated in FIG. 6, for example, is executed in a given cycle. If the process of the flowchart illustrated in FIG. 6 is started, the paper feed control unit 23 of the optional paper feed unit 20 first determines whether the paper feed preparation request has been received from the control unit 50 (step S31). When the process of step S13 illustrated in FIG. 4 is executed and hence it is determined that the paper feed preparation request transmitted from the control unit 50 has been received (when the determination result of step S31 is “YES”), the paper feed control unit 23 determines whether the paper stack P is arranged at the paper feed-enabled position (step S32).

When it is determined that no paper stack P is arranged at the paper feed-enabled position (when the determination result of step S32 is “NO”), the paper feed control unit 23 controls the lifting/lowering apparatus 21b to lift the bottom plate 21a and arrange the paper stack P at the paper feed-enabled position (step S32). On the other hand, when it is determined that the paper stack P is arranged at the paper feed-enabled position (when the determination result of step S32 is “YES”), the paper feed control unit 23 omits the process of step S32. According to the process of steps S32 and S33, the paper stack P is necessarily arranged at the paper feed-enabled position when the paper feed preparation request has been received from the control unit 50.

When it is determined that the paper feed preparation request transmitted from the control unit 50 has not been received (when the determination result of step S31 is “NO”) or when the process of steps S32 and S33 has ended, the paper feed control unit 23 determines whether the paper feed request has been received from the control unit 50 (step S34). When it is determined that no paper feed request has been received from the control unit 50 (when the determination result of step S34 is “NO”), a series of processes illustrated in FIG. 6 ends. On the other hand, when the process of step S23 illustrated in FIG. 5 is performed and hence it is determined that the paper feed request transmitted from the control unit 50 has been received (when the determination result of step S34 is “YES”), the paper feed control unit 23 determines whether the paper stack P has been arranged at the paper feed-enabled position (step S35).

When it is determined that no paper stack P has been arranged at the paper feed-enabled position (when the determination result of step S35 is “NO”), the paper feed control unit 23 controls the lifting/lowering apparatus 21b to lift the bottom plate 21a and arranges the paper stack P at the paper feed-enabled position (step S36). On the other hand, when it is determined that the paper stack P has been arranged at the paper feed-enabled position (when the determination result of step S35 is “YES”), the paper feed control unit 23 omits step S36. According to the process of steps S35 and S36, a process of arranging the paper stack P at the paper feed-enabled position is performed even when no paper feed preparation request has been received and the paper feed request has been received (when only the paper feed request is transmitted from the control unit 50 as in the related art)

If the above-described process ends, the paper stack P is arranged at the paper feed-enabled position regardless of whether the paper feed preparation request has been received from the control unit 50. Thus, the paper feed control unit 23 starts paper feeding to the main body unit 10 by controlling the pickup roller 22 (step S37). Then, the paper feed control unit 23 iterates the determination of whether the paper feeding has been completed (step S38).

When the paper feeding has been completed (when the determination result of step S38 is “YES”), the paper feed control unit 23 determines whether the paper feed preparation request has been received from the control unit 50 within a predefined retention period (step S39). Until the retention period has elapsed, the paper feed control unit 23 continuously arranges the paper stack P at the paper feed-enabled position. Here, when it is determined that the paper feed preparation request has been received from the control unit 50 within the retention period (when the determination result of step S39 is “YES”), the series of processes illustrated in FIG. 6 ends and the arrangement of the paper stack P at the paper feed-enabled position is maintained.

On the other hand, when it is determined that no paper feed preparation request has been received from the control unit 50 within the retention period (when the determination result of step S39 is “NO”), the paper feed control unit 23 controls the lifting/lowering apparatus 21b to lower the bottom plate 21a and arrange the bottom plate 21a at the standby position illustrated in FIG. 3B. When the process of step S40 ends, the series of processes illustrated in FIG. 6 ends.

Here, when a job indicating a print instruction for printing materials in which paper of the “A4” size and paper of the “B5” size are mixed is stored in the print queue Q, the process of the flowchart illustrated in FIG. 4 is performed at a point in time at which the job has been stored in the print queue Q and the print preparation request is transmitted from the control unit 50 to the optional paper feed unit 20. In addition, the process of the flowchart illustrated in FIG. 5 is performed and hence the paper feed request is sequentially transmitted from the control unit 50 to the paper feed unit 11 and the optional paper feed unit 20.

If the optional paper feed unit 20 receives the print preparation request transmitted from the control unit 50, control is performed to lift the bottom plate 21a arranged at the standby position to the paper feed-enabled position (steps S31 to S33). When the print request transmitted from the control unit 50 is received while the above-described control is performed, the paper feeding from the paper feed unit 11 is performed. When the control (control of lifting the bottom plate 21a to the paper feed-enabled position) performed by the optional paper feed unit 20 is completed while the paper feeding from the paper feed unit 11 is performed and the optional paper feed unit 20 receives the paper feed request transmitted from the control unit 50 (step S34), the pickup roller 22 is driven by the paper feed control unit 23 and paper is immediately fed from the optional paper feed unit 20 to the main body unit 10 (step S37).

The case in which a job indicating a print instruction for printing materials in which paper of, for example, the “A4” size, housed in the paper feed unit 11 and paper of, for example, the “B5” size, housed in the optional paper feed unit 20 are mixed is stored in the print queue Q has been described above. In this case, a print operation on the paper of the “B5” size housed in the optional paper feed unit 20 is performed based on the flowchart illustrated in FIG. 6 and a print operation on the paper of the “A4” housed in the paper feed unit 11 is separately performed.

When the paper feed preparation request has been input from the control unit 50 in this embodiment as described above, paper feed preparation control is performed to lift the bottom plate 21a until the paper stack P is arranged at the paper feed-enabled position by controlling the lifting/lowering apparatus 21b. Then, when the paper feed request has been input from the control unit 50 after the paper feed preparation control has been performed, paper feeding from the paper stack P arranged at the paper feed-enabled position is immediately started by controlling the pickup roller 22. Thus, in this embodiment, it is possible to shorten the waiting time for paper feeding according to a lift of the bottom plate 21a and hence to improve the productivity.

In addition, if the optional paper feed unit 20 has completed the paper feeding in this embodiment, the paper stack P is controlled to be continuously arranged at the paper feed-enabled position when the paper feed preparation request has been received from the control unit 50 within the predefined retention period. Thus, when paper feeding from a separate paper feed stage (the paper feed unit 11) is performed after the optional paper feed unit 20 has completed the paper feeding and the paper feeding from the original paper feed stage (the optional paper feed unit 20) is performed, the paper stack P is continuously retained at the paper feed-enabled position. Thus, the paper feeding from the original paper feed stage (the optional paper feed unit 20) can be immediately performed.

Although the paper feed apparatus and the image forming apparatus according to the embodiment of the present disclosure have been described above, the present disclosure is not limited to the above-described embodiment, and a change may be made freely within the scope of the present disclosure. An operation when a job indicating a print instruction for printing materials in which paper of different sizes is mixed is transmitted has been described in order to facilitate the description in the above-described embodiment. However, for example, a job indicating a print instruction for printing materials including paper of the same size housed in the optional paper feed unit 20 may be transmitted. Even in this case, it is possible to shorten the waiting time for paper feeding according to a lift of the bottom plate 21a.

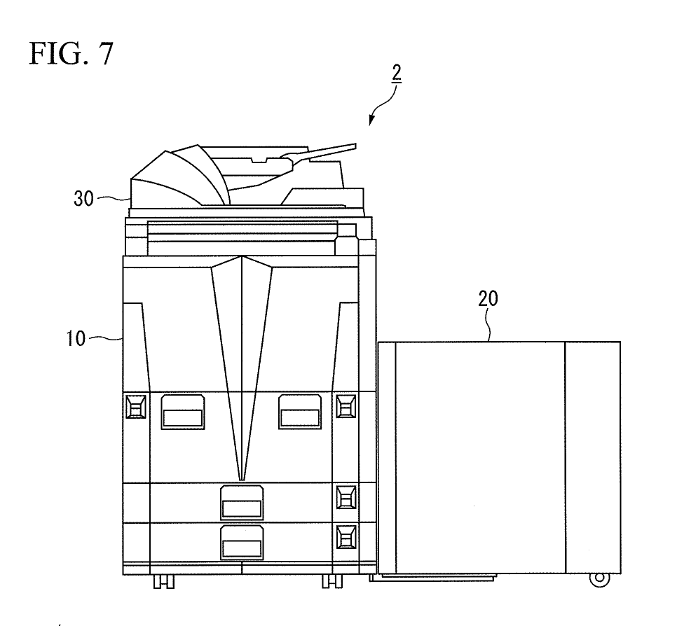

FIG. 7 is a front view illustrating a modified example of the paper feed apparatus and the image forming apparatus in accordance with the embodiment of the present disclosure. In the above-described composite device 1, the optional paper feed unit 20 is attached to the lower part (bottom) of the main body unit 10. However, as illustrated in FIG. 7, a composite device 2 in which the optional paper feed unit 20 is provided to be attached to the side of the main body unit 10 may be configured.

In addition, the case in which the optional paper feed unit 20 between the paper feed unit 11 and the optional paper feed unit 20 provided in the composite device 1 lifts the bottom plate 21a has been described in the above-described embodiment. However, the same optional paper feed unit 20 as that that lifts the bottom plate 21a can be used as the paper feed unit 11. Thereby, even when the print operation, for example, on paper of the “A4” size housed in the paper feed unit 11, is performed, the print operation can be performed based on the flowchart illustrated in FIG. 6. In this case, as in the optional paper feed unit 20, it is possible to shorten a time necessary to lift a paper stack housed in the paper feed unit 11 to the paper feed-enabled position.

In addition, although an example in which the image forming apparatus is the composite device has been described in the above-described embodiment, the above-described image forming apparatus may be applied to a printer, a copier, a facsimile, and the like.

While preferred embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

What is claimed is:

1. A paper feed apparatus comprising:
a paper housing unit configured to house paper at a first position;
a bottom plate provided in the paper housing unit and configured to retain the paper;
a moving unit configured to move the bottom plate between the first position and a second position;
a paper feed roller configured to feed the paper retained by the bottom plate at the second position; and
a paper feed control unit configured to cause the moving unit to move the bottom plate to the second position when a paper feed preparation request for requesting paper feed preparation has been input.

2. The paper feed apparatus according to claim 1, wherein the paper feed control unit causes the paper feed roller to feed the paper retained by the bottom plate when a paper feed request for requesting paper feeding has been input after causing the moving unit to move the bottom plate from the first position to the second position.

3. The paper feed apparatus according to claim 2, wherein the paper feed control unit causes the moving unit to retain the bottom plate at the second position during a predefined retention period after the paper feeding has been completed based on the paper feed request.

4. The paper feed apparatus according to claim 3, wherein the paper feed control unit causes the moving unit to move the bottom plate to a third position when the paper feed preparation request has not been input by the time the retention period has elapsed.

5. The paper feed apparatus according to claim 1, wherein the paper feed control unit causes the moving unit to move the bottom plate to the second position if the bottom plate is determined not to be at the second position when the paper feed preparation request has been input.

6. The paper feed apparatus according to claim 2, wherein the paper feed control unit causes the moving unit to move the bottom plate to the second position if the bottom plate is determined not to be at the second position when the paper feed preparation request has been input.

7. The paper feed apparatus according to claim 3, wherein the paper feed control unit causes the moving unit to move the bottom plate to the second position if the bottom plate is determined not to be at the second position when the paper feed preparation request has been input.

8. The paper feed apparatus according to claim 4, wherein the paper feed control unit causes the moving unit to move the bottom plate to the second position if the bottom plate is determined not to be at the second position when the paper feed preparation request has been input.

9. The paper feed apparatus according to claim 1, wherein the moving unit causes the bottom plate to move in a vertical direction.

10. The paper feed apparatus according to claim 3, wherein the retention period is one minute to five minutes.

11. The paper feed apparatus according to claim 4, wherein the third position is between the first position and the second position.

12. An image forming apparatus comprising:
a paper housing unit configured to house paper at a first position;
a bottom plate provided in the paper housing unit and configured to retain the paper;
a moving unit configured to move the bottom plate between the first position and a second position;
a paper feed roller configured to feed the paper retained by the bottom plate at the second position;
a paper feed preparation request output unit configured to output a paper feed preparation request for requesting paper feed preparation;
a paper feed control unit configured to cause the moving unit to move the bottom plate to the second position when the paper feed preparation request has been output;
a transfer unit configured to transfer a toner image of an image to be formed to the paper fed by the paper feed roller; and
a fixing unit configured to fix the toner image transferred by the transfer unit on the paper.

13. The image forming apparatus according to claim 12, further comprising:
a storage unit configured to sequentially store an image formation instruction for instructing to form an image and sequentially delete the image formation instruction for which the formation of the image has been completed,
wherein, every time the image formation instruction is stored in the storage unit, the paper feed preparation request output unit refers to the storage unit and determines whether to output the paper feed preparation request.

14. The image forming apparatus according to claim 13, wherein the paper feed preparation request output unit determines whether to output the paper feed preparation request based on whether the image formation instruction for using paper feeding from the paper feed roller is stored in the storage unit.

15. A paper feed method comprising:
housing paper at a first position of a paper housing unit;
moving a bottom plate, which is provided in the paper housing unit and retains the paper, to a second position when a paper feed preparation request for requesting paper feed preparation has been input; and
feeding, by a paper feed roller, the paper retained by the bottom plate at the second position.
